(19) United States
(12) Patent Application Publication
(10) Pub. No.: US 2026/0089070 A1
(43) Pub. Date: Mar. 26, 2026

(54) Diffusion-Based Network Traffic Generation

(71) Applicant: The University of Chicago, Chicago, IL (US)

(72) Inventors: Nick Feamster, Chicago, IL (US); Francesco Bronzino, Lyon (FR); Xi Jiang, Chicago, IL (US); Shinan Liu, Chicago, IL (US); Arjun Nitin Bhagoji, Mumbai (IN); Paul Schmitt, Honolulu, HI (US)

(21) Appl. No.: 19/336,926

(22) Filed: Sep. 23, 2025

Related U.S. Application Data
(60) Provisional application No. 63/698,844, filed on Sep. 25, 2024.

(51) Int. Cl. H04L 41/16; G06V 10/75; G06V 10/82; H04L 1/00; H04L 43/045; H04L 47/34; H04L 69/00; H04L 69/22

(52) U.S. Cl. CPC H04L 41/16; G06V 10/753; G06V 10/82; H04L 1/0083; H04L 43/045; H04L 47/34; H04L 69/03; H04L 69/22

(57) ABSTRACT

An implementation may involve: providing, to an image diffusion model, a prompt that describes characteristics of network traffic; receiving, from the image diffusion model, an image representing the network traffic, wherein the image comprises a matrix of pixel values representing packets of the network traffic in a presence-based format; transforming the pixel values into a trace of the network traffic, wherein the trace encodes at least packet header values of the packets; applying, to the trace, protocol compliance rules that relate to the packet header values; and outputting the trace in a binary format.

### CROSS-REFERENCE TO RELATED APPLICATION

This application claims priority to U.S. provisional patent application No. 63/698,844, filed Sep. 25, 2024, which is hereby incorporated by reference in its entirety.

### GOVERNMENT LICENSE RIGHTS

This invention was made with government support under contracts 2126327 and 2124393 awarded by the National Science Foundation. The government has certain rights in the invention.

### BACKGROUND

Datasets of labeled network traces are useful for a multitude of machine learning (ML) tasks in networking, yet their availability is hindered by privacy and maintenance concerns, such as data staleness. To overcome this limitation, synthetic network traces can often augment existing datasets. Unfortunately, current synthetic trace generation methods, which typically produce only aggregated flow statistics or a few selected packet attributes, do not always suffice, especially when model training relies on having features that are only available from packet traces. This shortfall manifests in both insufficient statistical resemblance to real traces and poor performance on ML tasks when employed for data augmentation.

### SUMMARY

The embodiments herein apply diffusion models to generate high-resolution synthetic network traffic traces. A tool that uses a finely tuned, controlled variant of an image diffusion model can generate synthetic network traffic that is high fidelity and conforms to protocol specifications. Evaluations demonstrate that packet captures of traffic generated from this tool can achieve (i) higher statistical similarity to real data, and (ii) better ML model performance than current state-of-the-art approaches (e.g., GAN-based techniques). Furthermore, the synthetic traces are compatible with common network analysis tools and support a myriad of network tasks. Thus, they can serve a broader spectrum of network analysis and testing tasks, extending beyond ML-centric applications.

A system of one or more computers or computing systems can be configured to perform particular operations or actions by virtue of having software, firmware, hardware, or a combination thereof installed that in operation causes or cause the computer(s) or systems(s) to perform the actions. One or more computer programs can be configured to perform particular operations or actions by virtue of including instructions that, when executed by data processing apparatus, cause the apparatus to perform the actions.

One general aspect involves a method. The method includes providing, to an image diffusion model, a prompt that describes characteristics of network traffic. The method also includes receiving, from the image diffusion model, an image representing the network traffic, where the image may include a matrix of pixel values representing packets of the network traffic in a presence-based format. The method also includes transforming the pixel values into a trace of the network traffic, where the trace encodes at least packet header values of the packets. The method also includes applying, to the trace, protocol compliance rules that relate to the packet header values. The method also includes outputting the trace in a binary format.

Another general aspect involves a further method. This method includes obtaining a trace of captured network traffic including a sequence of packet headers. The method also includes converting the captured network traffic into image-based representations, where each respective image of the image-based representations includes a respective matrix of pixel values representing respective packets of the captured network traffic in a presence-based format. The method also includes associating the image-based representations with prompts describing characteristics of the captured network traffic. The method also includes fine-tuning an image diffusion model with the image-based representations and associated prompts. The method also includes storing the image diffusion model for subsequent use.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts procedures for network traffic to image conversion, diffusion model fine tuning, and generation of synthetic network traffic in accordance with a protocol compliance heuristic, in accordance with example embodiments.

FIG. 4 depicts modeling network traffic as images and generating synthetic network traffic from such images, in accordance with example embodiments.

FIG. 5 depicts transport control protocol (TCP) rules and dependencies, in accordance with example embodiments.

FIG. 6 depicts accuracy and performance characteristics, in accordance with example embodiments.

FIG. 7 is a flow chart, in accordance with example embodiments.

FIG. 8 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Herein, a “software application” may be any structured set of computer-executable instructions that can perform a specific function or a set of related functions. This encompasses programs that operate in various computing environments, including but not limited to standalone desktop applications, mobile applications, web-based applications, embedded systems software, cloud-based services, distributed computing applications, and operating systems. Software applications may involve the processing, manipulation, and management of data, control of hardware devices, execution of various algorithms, provisioning of user interfaces for interaction, and communication with other software applications or services. The term is inclusive of software that performs an array of functions, whether pre-installed, downloaded, accessed remotely, or delivered as a service. This definition is intended to cover a broad range of software implementations, architectures, and platforms, recognizing the evolving nature of technology and software development practices.

Furthermore, herein the terms “optimize,” “maximize,” “minimize,” and any related expressions are not to be construed as indicating that the disclosed embodiments necessarily achieve the absolute best possible outcomes according to these criteria. Instead, these terms should be interpreted as representing objectives or goals that the embodiments aim to achieve to varying degrees under certain conditions. The use of such terms is intended to describe general intents or directions, rather than a definitive statement of performance.

Moreover, the effectiveness and efficiency of the embodiments herein may vary based on a multitude of factors, including but not limited to the specific application, operating environment, and the precise configuration thereof. As such, while the embodiments may strive to optimize, maximize, or minimize certain parameters in certain scenarios, it is not guaranteed that the results will always represent the highest degree of optimization, maximization, or minimization possible. Instead, these terms should be understood as conveying the intent to improve or enhance certain aspects relative to a baseline or comparative state.

Therefore, the scope of these embodiments should not be limited or interpreted to imply that they always deliver the optimal, maximal, or minimal outcomes. Rather, the embodiments are intended to offer improvements or enhancements in alignment with the stated objectives, recognizing that such improvements may be context-dependent and subject to practical limitations. The discussion herein should be understood and interpreted with this perspective in mind, so that this broad and flexible nature is appropriately appreciated.

As discussed herein, the Berkeley packet capture (PCAP) format defines a standardized container for storing network traffic traces, where each file includes a global header followed by a plurality of packet records. The global header defines attributes of the capture session including byte order, link-layer encapsulation type, and timestamp precision. Each packet record comprises a per-packet header and a captured data section, the per-packet header including metadata such as a timestamp, captured length, and original length of the packet, and the captured data section including the raw packet bytes (e.g., header and payload) as observed on the network interface. The PCAP format thereby enables storage and replay of network traffic in a manner that is protocol-agnostic and interoperable with analysis tools and network testing systems.

### I. Example Computing Devices and Environments

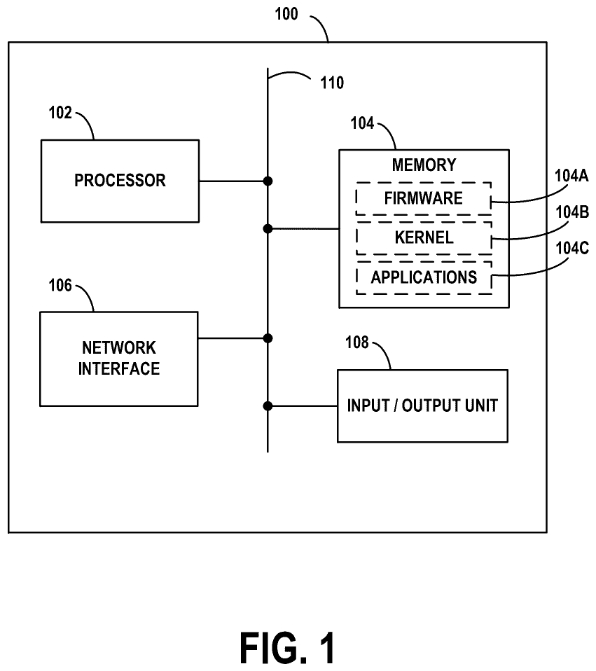

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet local-area media, such as coaxial cables or power lines, or over wide-area media, such as fiber-optic connections (e.g., Synchronous Optical Network and Synchronous Digital Hierarchy) or other technologies. Network interface 106 may additionally take the form of one or more wireless interfaces, such as IEEE 802.11 (Wifi), Bluetooth, global positioning system (GPS), or a wide-area wireless interface (e.g., using 4G or 5G cellular networks). However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, Bluetooth, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed as a cluster of server devices. The exact physical location, connectivity, and configuration of these computing devices may be unknown and/or unimportant to client devices. Accordingly, the computing devices may be referred to as “cloud-based” devices that may be housed at various remote data center locations.

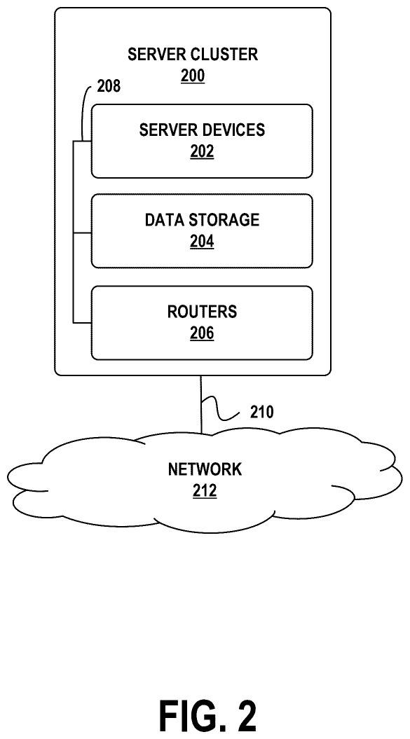

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed between one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the HyperText Markup Language (HTML), the extensible Markup Language (XML), Cascading Style Sheets (CSS), and/or JavaScript Object Notation (JSON), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages. Alternatively or additionally, Java may be used to facilitate generation of web pages and/or to provide web application functionality.

### II. Example Generation of Synthetic Network Traffic

Modern networks are increasingly reliant on ML techniques for a wide range of management tasks, ranging from security to performance optimization. A central impediment when training network-focused ML models is the scarcity of labeled network datasets, as their collection and sharing are often associated with high costs and privacy concerns, particularly when data is collected from real-world networks. Unfortunately, existing public datasets rarely receive updates, making them static and unable to reflect evolving network behavior. These limitations hinder the ability to train robust ML models that accurately reflect evolving real-world network conditions.

These challenges can be addressed through the creation of new synthetic network traces based on existing datasets. This approach aims to preserve the inherent characteristics of network traffic while introducing variations, thereby enhancing dataset size and diversity. Unfortunately, current state-of-the-art synthetic trace generation methods, particularly those based on Generative Adversarial Network (GAN) based methods, are not always sufficient for producing high-quality synthetic network traffic. Specifically, these approaches tend to focus on a limited set of attributes or statistics, as early ML for network tasks often relied on basic flow statistics for classification. With recent ML advancements utilizing detailed raw network traffic to achieve enhanced classification accuracy, there is a clear need for synthetic traffic generation that includes the intricate, potentially unforeseen patterns present in full network traces.

Existing traffic generation methods face two main issues: (1) a lack of statistical similarity with real data due to the limited attributes in existing methods, making the synthetic data highly sensitive to variations, and (2) unsatisfactory classification accuracy when synthetic statistical attributes are used to augment existing datasets. Moreover, their simplistic attribute focus and disregard for transport and network layer protocol behaviors prevent their use with traditional networking tools such as tcpreplay (lightweight TCP port forwarding tool that relays traffic from one port to another, often used for debugging) or Wireshark (network protocol analyzer that captures and inspects packet data in for troubleshooting, analysis, and/or security monitoring).

Fortunately, the general increase in available computational power and the breakthroughs in high-resolution image generation techniques, particularly diffusion models, offer a promising avenue to overcome these challenges. In contrast to GANs, diffusion models are able to capture both broad patterns and detailed dependencies. This inherent generative quality makes them an ideal choice for producing network traces with high statistical resemblance to real traffic and full packet header values. By incorporating conditioning techniques, diffusion models can generate structured data that conforms to specific network properties, which ensures the desired sequential inter-packet characteristics and rough protocol dependencies. Moreover, the gradient dynamics of the training process in diffusion models is much more stable than GANs. These attributes collectively position diffusion models as a compelling choice for advancing the state-of-the-art for synthetic network trace generation, addressing the extant limitations of current methodologies.

### A. Example Technical Improvements

Notably, the embodiments herein facilitate a number of technical advantages over prior techniques. These include but are not limited to the following.

Generation of synthetic network traces with high resemblance to real traffic: Using diffusion techniques, a two-fold strategy is employed: (1) a conversion process for transforming raw packet captures to image representations (and vice versa), and (2) fine-tuning a text-to-image diffusion model based on packet capture-converted images for generating synthetic packet captures. To improve resemblance to real network traffic, controlled generation techniques are used to maintain fidelity to the protocol and header field value distributions observed in real data and, post generation, use domain knowledge-based heuristics to finely check and adjust the generated fields, ensuring their semantic correctness in terms of compliance with transport and network layer protocol rules.

Improved classification accuracy in ML scenarios with synthetic network traffic augmentation: By integrating generated network traffic into the real dataset at varying proportions during training and testing, there is a general increase in accuracy compared to the state-of-the-art generation methods. This improvement is attributed to the synthetic data's significantly high statistical resemblance to real datasets. Additionally, class imbalance issues are addressed, enhancing the accuracy of ML models in such cases.

Extended applicability of synthetic network traffic for network analysis and testing beyond ML tasks: Generated network traffic can be converted into raw packet captures suitable for traditional network analysis and testing tasks. Moreover, statistical features for various network operations can be effectively extracted from the generated network traffic.

Protocol-compliant synthetic traffic generation: By enforcing both intra-packet and inter-packet protocol dependency rules during post-processing, the generated network traffic is not only statistically realistic but also syntactically valid, thereby enabling their direct use in tools such as intrusion detection systems, replay frameworks, and protocol analyzers without requiring manual correction.

Efficient adaptation of large-scale diffusion models: Using parameter-efficient fine-tuning techniques such as Low-Rank Adaptation (LoRA), the embodiments herein enable large, pre-trained diffusion models to be specialized for network traffic domains without incurring prohibitive computational or memory costs, improving training feasibility on commodity hardware.

The foregoing discussion of technical improvements is not intended to be exhaustive. The embodiments described herein may yield additional advantages and benefits beyond those expressly recited, and such advantages may vary depending on particular implementations. Accordingly, the technical improvements listed above are illustrative rather than limiting, and other technical improvements may be realized within the scope of the disclosed subject matter.

### B. Motivation

The following are examples of motivating factors that led to the embodiments herein. Nonetheless, other motivations may have been present regardless of whether they were known at the time of the invention.

The use of publicly available network datasets has significantly aided advancements in applying ML to networks, as well as network analysis and testing methodologies. For example, models trained on network datasets have been helpful in tackling challenges like anomaly detection, traffic classification, and network optimization, which in turn enhances network security and performance. Additionally, these datasets are valuable for network analysts, aiding in understanding network behaviors, identifying performance issues, and evaluating the performance of network security tools like firewalls and intrusion detection systems.

Well-known network datasets such as CAIDA, MAWI, UNSW-NB15, and KDD have been used for numerous research projects in network science. However, the lack of updated datasets often hinders further progress. Those with the means to capture large-scale traffic, typically network operators and organizations with specialized hardware and network, are often hesitant to share their data due to the risk of exposing sensitive or personally identifiable information (PII).

Even when entities are amenable to sharing, the task of providing consistent updates and ensuring reliable labels for sanitized data is daunting. Labeling network data is inherently challenging because of its dynamic nature, such the continuous evolution of network behaviors and threats. Notably, the CAIDA, UNSW-NB15, KDD Cup 99, and NSL-KDD datasets were last updated in 2020, 2015, 1999, and 2009 respectively, revealing notable gaps in data recency which render them less reflective of evolving network dynamics. Even frequently updated datasets like MAWI are not exempt from issues, with instances of missing data from hardware failures and substantial duplicate traces. While not an exhaustive list of datasets, the issues highlighted are common across the board, accentuating the need for newer data to fuel ongoing network research and analysis.

Data augmentation through synthetic data has proven effective in many fields. In computer vision, for instance, synthetic images have improved model performance, especially when there is a shortage of labeled data. The success of synthetic data augmentation is largely attributed to generative methods which have showcased remarkable versatility in a variety of domains.

In medical imaging, GANs have been harnessed to augment datasets, significantly enhancing the performance of diagnostic models. In the domain of natural language processing, Variational Autoencoders (VAEs) have been utilized to create synthetic text data, aiding in tasks such as sentiment analysis and language translation. In audio processing, the advent of WaveGAN has facilitated the expansion of sound datasets, proving useful for applications like speech recognition and sound event detection.

Translating these successes to the networking domain, certain endeavors have emerged, attempting to augment network datasets through the generation of synthetic network data. A notable state-of-the-art attempt in this regard is NetShare which utilizes GANs to produce IPFIX/NetFlow-style statistics on network traffic. For simplicity, this general type of aggregated statistical attributes is referred to as NetFlow. Yet, its focus on statistical properties might miss important network patterns essential for high ML accuracy. At the same time, the limited number of attributes that it focuses on prohibits the generation of comprehensive, raw network traffic such as packet captures, which are useful for additional non-ML tasks such as network analysis and testing. Notably, other non-generative methods like TRex and NS-3 are not considered because, while useful for specific tasks, they lack the flexibility needed for broader dataset augmentation. They often rely on predefined templates or rules, which may not capture the evolving nature of network traffic or the complex interactions between various network protocols and applications.

A short case study on NetShare is provided, which is the current state-of-the-art network data generation method that produces NetFlow attributes, i.e., derived statistics from raw network traffic flows. Following the method in the original NetShare paper, the accuracy of a variety of ML models, such as Random Forest (RF), Decision Tree (DT), and Support Vector Machine (SVM), were tested under three scenarios: (1) training and testing on real NetFlow data, (2) training on NetShare synthetic data and testing on real data, and (3) vice versa. Doing so involves a traffic classification task using a curated dataset. The classification task is divided into micro and macro levels. On the micro level, the goal is to classify network traffic flows into specific applications, encompassing 10 distinct classes such as video streaming and e-commerce. On the macro level, the aim is to classify network traffic flows into broader service categories, spanning three classes, like streaming and web browsing.

TABLE 1
Comparison of model accuracy using real, synthetic Net-Flow
data, and raw network traffic. Results highlight a decrease
in accuracy with NetShare's synthetic data and a boost when
using raw traffic. Only the top-performing model is displayed.

| Training/ | Data Format | Highest Accuracy Model | | | |
|---|---|---|---|---|---|
| Testing | (Generation Method) | Macro-Level | | Micro-Level | |
| Real/Real | Network traffic | 1.00 | (SVM) | 0.978 | (SVM) |
| | (PCAP) (N/A) | | | | |
| | NetFlow (N/A) | 0.86 | (RF) | 0.648 | (DT) |
| Synthetic/Real | NetFlow (NetShare) | 0.396 | (RF) | 0.140 | (SVM) |
| Real/Synthetic | NetFlow (NetShare) | 0.503 | (SVM) | 0.102 | (RF) |

The results from Table 1 showcases a clear drop in accuracy when models are trained or tested on synthetic NetFlow data generated by NetShare compared to when only real NetFlow data is used, irrespective of the classification level. This points to a likely shortfall of NetShare in preserving critical distinguishing feature values inherent in the real dataset, which adversely affects the models' ability to accurately classify network traffic.

Following the NetShare evaluation, the accuracy achieved with real NetFlow data was compared to that when models train and test on raw network traffic in Berkeley packet capture (PCAP) format. This comparison underscores the information loss encountered when using NetFlow data and the potential classification performance gain from leveraging raw network traffic: The highest accuracy is achieved with raw network traffic, with SVM arriving at near-perfect accuracy.

These observations lead to two main insights: First, the need for synthetic data generation methods to effectively preserve distinguishing feature values to maintain classification accuracy. Second, the advantage of using raw network traffic over NetFlow data due to its richer information content. The push towards generating raw network traffic to retain the fine-grained details and statistical properties of real network traffic, appears to be a useful step to overcome the limitations observed with NetShare generated data and NetFlow data. Conversely, a noticeable decrease in accuracy is observed with real NetFlow data, suggesting that its limited feature set adversely affects classification accuracy.

Besides the performance of synthetic network data in ML tasks, another important metric to validate its usefulness is its applicability to traditional network analysis and testing tasks, such as packet-wise analysis and replay. This is desirable because, unlike other forms of data such as images where the quality of the data can be inferred relatively easily by visual resemblance to real images, it is hard for network experts to manually examine raw network traffic to verify its quality. NetFlow data, encapsulating aggregated or derived statistics from raw network traffic flows, lacks detailed information desriable for these tasks.

For instance, network analysts often use tools like Wireshark to investigate network traffic details like packet headers and sequences to diagnose issues or assess performance, such as tracing latency causes or detecting unauthorized access. However, the high-level statistical nature of NetFlow data omits such fine-grained details, rendering it inadequate for such in-depth analysis. Furthermore, synthetic NetFlow data cannot be retransmitted or replayed over network interfaces using tools like tcpreplay. Retransmitting network traffic is pivotal for various network testing and validation scenarios, such as evaluating the performance of network security tools under realistic traffic conditions or stress-testing network infrastructure. The absence of packet-level details in NetFlow data precludes its use for retransmission tasks. Moreover, certain network analysis tasks require deriving additional attributes directly from raw network traffic. For example, estimating the window size or investigating the distribution of packet sizes across a network necessitates access to raw traffic data. These computations are desirable for understanding network behavior and improving network configurations.

Converting high-level statistical NetFlow data back to raw network traffic, such as packet captures, is inherently challenging due to the loss of detailed attributes like header values and flags, thereby limiting the utility of synthetic NetFlow data for a myriad of non-ML network tasks. This challenge underscores the advantages of generating raw network traffic. At the same time, existing network data generation methods often neglect to ensure that synthetic data adhere to transport and network layer protocol rules found in real network traffic, which are useful for traditional network analysis and testing tools. For example, a protocol constraint is that packet length frames must conform to specific sizes as per protocol standards. Generating synthetic data with incorrect frame sizes could lead to misinterpretations in data analysis or malfunctions in network testing scenarios. Other protocol constraints, like correct sequence numbers in TCP transmissions, valid checksums, and appropriate flag settings, are also useful as they affect how network devices and analysis tools interpret and process the data. Hence, adhering to protocol rules is desired for the accuracy and reliability of network analysis and testing tasks, and serves as a gauge for the quality of synthetic network data generated.

### C. Example Diffusion Models and Techniques for Generating Synthetic Traffic

The embodiments herein are generally referred to as NetDiffusion, a framework that harnesses controlled text-to-image diffusion models to generate synthetic raw network traffic that complies with transport and network layer protocol rules. This approach not only elevates classification accuracy when utilized for data augmentation in ML scenarios but also facilitates a broad range of network analysis and testing tasks, overcoming the limitations described above.

Diffusion models synthesize data by modeling data generation as the process of noise removal from noisy data (referred to as the reverse process). At training time, a complex ML model, usually a neural network, is trained to predict noise that is sequentially added to real data (the forward process). Running the forward and reverse processes in the latent space of a model has been found to generate better quality data. Consider an initial noise vector (z) in the latent space. The goal of diffusion models is to transform z into a data point (x) drawn from the desired distribution. The idea is to define a differential equation that controls the transformation from z to x over a series of discrete time steps. The rationale behind this is that by breaking down the generation process into a series of incremental diffusion steps, the model can capture intricate dependencies and details in the data manifold. A component of this approach is score-based generative modeling, where the gradient of the data log-likelihood with respect to the data (often termed the “score” function) is estimated. Modeling the score function is preferable because directly modeling the probability distribution poses challenges, especially in obtaining the correct normalization constant. Diffusion models have been adopted most effectively in the context of text-to-image synthesis, where images matching a given text prompt are to be generated. The text prompt serves as a conditioning variable to guide the reverse process toward generating an image that semantically aligns with the text prompt. By iteratively applying the score function, conditioned on the text prompt, the model steers the data from a simple prior distribution (like Gaussian noise) to the desired complex image distribution. In the embodiments herein, the text prompts characterize the specific classes/types of network traffic to be generated.

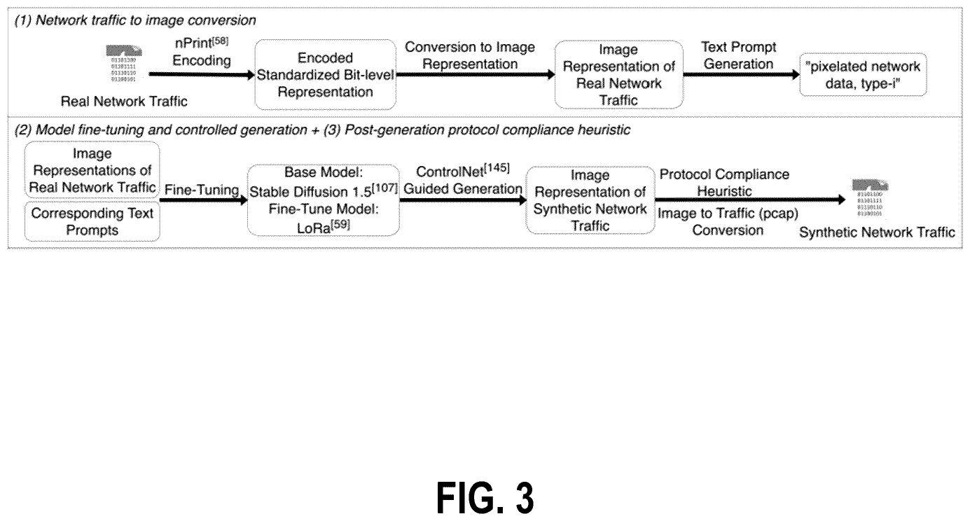

These principles of diffusion models are extended to network traffic data via the NetDiffusion framework. This approach is structured around three primary components: (1) converting raw network traffic in packet capture (PCAP) format into image-based representations; (2) fine-tuning a diffusion model to enable controlled text-to-traffic generation with high distributional similarity across header fields to real-world network traffic; and (3) domain knowledge-based post-processing heuristics for detailed modification of generated network traffic for high level of protocol rule compliance. FIG. 3 depicts a process for network traffic to image conversion, fine-tuning of a diffusion model, and generation of synthetic network traffic, steps of which are discussed below.

### 1. Network Traffic to Image Conversion

Network traffic data, with intricate inter-packet dependencies and vast ranges of attributes, presents a complex landscape that introduces specific challenges when it comes to accurate representation and efficient learning. Network traffic exhibits high dimensionality, particularly when using standardized representations such as nPrint. For instance, between the IP and TCP headers alone, there is an abundance of fields (e.g., IP addresses, ports, sequence and acknowledgment numbers, flags, etc.). nPrint uses a bit-level and standardized representation to have a consistent format for each packet by accounting for all potential header fields (even if not present in the original packet). For instance, while a TCP packet won't have UDP header bits, the nPrint still includes placeholders for these bits. While this supports a uniform input structure for ML models, the attribute count per packet often exceeds a thousand. This high dimensionality introduces computational bottlenecks for generative models.

Additionally, each network traffic trace, considered as a single network flow/session, inherently contains sequential dependencies between packets. For example, in TCP, packets need to follow a particular sequence to ensure the integrity and reliability of data transmission. The order of packets, dictated by sequence and acknowledgment numbers, is useful to reconstruct the transmitted data accurately at the receiver's end. These dependencies are also beneficial to improve ML classification accuracy as they may be unique to different classes of network traffic. Traditional tabular formats fall short in preserving these sequential relations due to their static nature, which could lead to the misrepresentation of the underlying network behavior.

Since recent strides in synthetic data generation have centered around image generation, these methods can be leveraged to generate high-fidelity synthetic network data with low computational complexity. The reasons for adapting these models include the following.

Maturity of image generative models—the advancements in the domain of image generative models, such as diffusion models, offer a robust foundation to produce detailed synthetic network traffic. These models have been optimized over years to understand and reproduce intricate patterns in high-resolution images.

Spatial hierarchies and connectivity—images inherently capture spatial hierarchies, which is useful for representing intricate inter-packet and intra-packet dependencies in network traffic. Pixels in images naturally form patterns and structures. Deep learning models, especially convolutional neural networks (CNNs), are adept at exploiting these structures to capture both local and global dependencies. Unlike traditional tabular formats where data points might be perceived as independent entities, images inherently emphasize the significance of a packet concerning its neighboring packets, preserving contextual information.

Visualization and interpretability—image representations offer a intuitive way to discern packet flows, anomalies, and patterns in network traffic.

Research and tools availability—the extensive research and tools available in computer vision mean that scalability and optimization are already mature, providing a significant advantage when handling high-dimensional data like network traffic.

To arrive at image representations of network traffic, packet captures (e.g., in PCAP format) are encoded using nPrint, which converts network traffic into standardized bits where each bit corresponds to a packet header field bit, as shown in FIG. 3. This binary representation is simple yet effective, where the presence or absence of a bit in the packet header is denoted as 1 or 0 respectively, and a missing header bit is represented as −1. This encoding scheme provides a standardized representation irrespective of the protocol in use. The payload content might not be encoded since it is often encrypted. However, the size of the packet payloads can be inferred from other encoded header fields such as the IP Total Length fields.

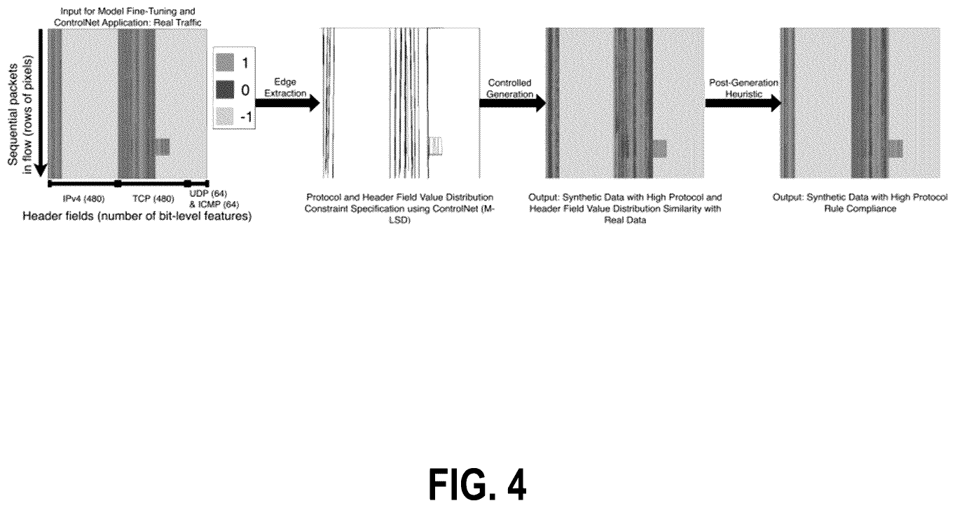

A sequence of packets in this format are converted into a matrix, which is then interpreted as an image. The colors green, red, and gray represent a set bit (1), an unset bit (0), and a vacant bit (−1), respectively. This color coding provides a visually intuitive representation of the network traffic. Due to the limitations in the generative models' capability to handle very high dimensional data, packets are arranged into groups of 1024. This constraint could be revisited to accommodate larger groups of packets. Thus, network traffic (e.g., in PCAP format) is transformed into an image with dimensions of 1088 pixels in width and 1024 pixels in height, with each row of pixels representing a packet in the network traffic flow as shown in FIG. 4.

Any image in this format can be converted back (e.g., to PCAP format) in a straightforward manner. This representation not only preserves the complexity of the data but also retains the essential sequential relationships among packets, laying a robust foundation for the ensuing steps in the NetDiffusion pipeline.

### 2. Fine-Tuning the Diffusion Model and Controlled Generation

Given a real, labeled network traffic dataset, the network traffic flows are transformed into their corresponding image representations as previously described. Leveraging these image-based representations, a generative model is then fine-tuned, specifically a diffusion model, to produce synthetic network traffic. The decision to employ diffusion models for image-based network traffic generation over other generative approaches, such as GANs, is anchored on several compelling advantages.

First, diffusion models excel in capturing and replicating intricate data distributions with remarkable fidelity. This is desirable, given the complex and nuanced patterns inherent in real network traffic. The ability of diffusion models to closely mimic these patterns ensures that the synthetic traces they produce have high resemblance to real traces.

Second, diffusion models, through techniques like latent diffusion, are adept at generating and managing high-resolution images. This capability is desirable for the NetDiffusion framework, where the image representation of network traffic demands high resolution for accuracy and detail retention. While diffusion models can be tailored to handle tabular data directly, this may forgo the distinct benefits of image representations, such as capturing spatial and sequential intricacies, as previously discussed.

Third, by allowing for conditional generation based on textual prompts, text-to-image diffusion models can be instructed to generate network traffic that mirrors specific classes or types, offering an unparalleled fusion of precision and versatility. The model learns the relationship between text and image during its training phase by adjusting its reverse diffusion trajectory based on the given textual prompt. This makes it such that the final generated image aligns with desired image distribution. This becomes invaluable when the need arises to produce specific classes of network traffic or to conform to protocol rules and other essential network characteristics.

Fourth, the nature of diffusion models ensures a transparent generation process, leading to reproducible results. Such transparency is desirable for producing network traces that meet specific patterns or constraints, as it shows good interpretability. Moreover, unlike the often unpredictable training dynamics of GANs due to their adversarial nature, diffusion models exhibit stable training behavior and well-behaved gradient dynamics. This stability not only provides consistent and anomaly-free output but also streamlines the optimization process. In totality, these advantages make diffusion models a robust and versatile choice for the generation of synthetic network traces, effectively addressing the challenges and constraints observed with other generative techniques.

Training generative models, especially those as sophisticated as diffusion models, from scratch can be resource-intensive and time-consuming. This is particularly true when considering existing base models like Stable Diffusion 1.5 which have been pre-trained on the LAION-5B dataset containing over 5.85B CLIP-filtered image-text pairs. While the out-of-the-box Stable Diffusion model is undeniably potent, it cannot be used directly to synthesize network traffic because it was designed to cover a broad spectrum of patterns and intricacies, causing it to lack the depth needed in specific generation tasks. For instance, generating images based on task-specific prompts might yield results that, although thematically aligned, lack the precision and high-fidelity one might expect. In this case, a “streaming video traffic” prompt might yield a generic image like a highway scene within a video. This is particularly evident when the textual description provided has multiple potential visual interpretations, causing the model to produce images that may be blurry or off-target. By fine-tuning Stable Diffusion on specific network datasets, these limitations can be addressed. Fine-tuning augments the model's expressiveness, enabling it to be better associated with specific patterns or embeddings of the network traffic domain.

As a result, in this framework, Stable Diffusion 1.5 is built upon and fine-tuned on specific network datasets as shown in FIG. 3, making it aptly suited for generating synthetic network traffic that mirrors the complexities and nuances of real-world network traffic. To facilitate this fine-tuning, Low-Rank Adaptation (LoRa) is employed, which is a training technique tailored to swiftly fine-tune diffusion models, particularly in text-to-image diffusion models. It enables the diffusion model to learn new concepts or styles effectively, while maintaining a manageable model file size. This is beneficial given the traditionally large sizes of models like Stable Diffusion, which can be cumbersome for storage and deployment. With LoRa, the resultant models are compact, striking a balance between file size and training capability. This compactness does not sacrifice the model's ability but rather applies minute yet effective changes to the base/foundational model, ensuring that the core knowledge remains intact while adapting to new data.

Next is a fine-tuning process in which classes of real network traffic are sampled from the dataset. These traffic samples are then transformed into their image representations in accordance with the discussion above. For each of these images, a unique encoded text prompt (e.g., “pixelated network data, type-0” for a specific type of video traffic) is crafted that succinctly describes its class type. The choice of encoded prompt, though seemingly simplistic, achieves two main objectives. It offers a specific vocabulary that reduces ambiguity and allows the model to home in on the network traffic's nuances. Additionally, it reduces interference from the base model's original word embeddings, improving the generative process. Experimentally, it was found that this specific prompt structure provides a balance between specificity and simplicity to prevent overfitting and misinterpretations, leading to better results.

Subsequently, these image-text pairs are fed into the fine-tuning process, where the base Stable Diffusion model, augmented with LoRa, learns to generate network traffic images conditioned on the prompts. Merging the Stable Diffusion models with the adaptability of LoRa creates a potent mechanism to generate high-fidelity, synthetic network traffic images, tailored to specific requirements. Its crux lies in enabling the diffusion model to learn new concepts or styles effectively, while maintaining a manageable model file size.

After the diffusion model is fine-tuned, it can be used for generating the desired class of synthetic network traffic. This is achieved by supplying the appropriate text prompts to the models to produce the image representations of the traffic. As noted, diffusion models operate by simulating a reverse process from a simple noise distribution to the data distribution, which enables them to capture and replicate the intricate patterns inherent in real-world data. The noise is progressively reduced over several steps, allowing the model to gradually refine the generated image until it closely resembles genuine network traffic patterns.

An example of synthetic network traffic is shown as an image representation for e-commerce traffic in FIG. 4. Notably, FIG. 4 depicts using ControlNet to detect regions present in the original traffic and to make it so that protocol and header field value distribution conformance by generating within specified regions. FIG. 4 also depicts applying a post-generation heuristic to refine field details for protocol conformance.

This prompt-based generation process facilitates the creation of a synthetic network traffic dataset in the standardized binary representation, wherein the dataset is tailored to specific class distribution requirements. For instance, to curate a dataset with a certain class distribution and size, one would provide the corresponding quantity of text prompts per class and activate the generation process accordingly.

However, a challenge arises from the inherent flexibility of general diffusion models. While they are designed to foster creativity in the generated output, it can lead to anomalies in the context of network traffic generation. For example, generated traffic might incorrectly populate packet header fields, leading to protocol distribution discrepancies between synthetic and real traffic. Such deviations can compromise ML accuracy and make it arduous to ensure strict adherence to protocol rules as described later. To make it so that the generated traffic closely aligns with the prevalent protocol and header field value distributions observed in real traffic, certain constraints are introduced during the generation process. If, for instance, the actual e-commerce network traffic primarily consists of TCP packets, the generation process should prioritize populating header fields associated with TCP packets. This approach makes it so that the generated traffic image predominantly features green (set bit) or red (unset bit) pixels corresponding to TCP packet headers, while other pixels remain gray (vacant bit). Moreover, consistent bit characteristics within headers, such as consistently unset bits, should be mirrored in the synthetic output.

Leveraging the controllable nature of diffusion models, ControlNet was incorporated into the generation process. ControlNet is a neural network architecture designed to add spatial conditioning controls to large, pre-trained text-to-image diffusion models. It capitalizes on the robust encoding layers of these models, which are pre-trained with vast datasets, to learn a diverse set of conditional controls. With “zero convolutions”, the architecture gradually grows its parameters from an initialized state, so that no adverse noise affects the fine-tuning. ControlNet can work with a range of conditioning controls, from edges and depth to segmentation and human poses. It offers flexibility in training, demonstrating robustness with both small and extensive datasets. The specific use case of ControlNet herein leveraged M-LSD straight line detection for detection the boundaries between fields that are supposed to be populated and those that are not. Other edge detection methods such as Canny edge detection produce similar results. Such line or edge detection methods are effective because they align with the inherent columnar consistency present in packet traces.

Incorporating ControlNet allows the synthetic generation process to more closely emulate the protocol and header field value distributions observed in real network traffic. This reduces deviations and ensures that the generated packets largely adhere to the expected protocol type and header field values, enhancing the quality and reliability of the synthetic network traffic dataset. And while ControlNet offers coarse-grained control, determining which image regions to populate, the diffusion model provides fine-grained control, specifying individual pixel values which further contributes to high resemblance to real traffic.

### 3. Improving Transport and Network Layer Protocol Compliance

Utilizing the controlled diffusion model, encoded network traffic was generated that adeptly resembles the protocol and header field value distributions inherent in real-world data. The encoded format not only captures feature observed in real network traffic but also minimizes the statistical disparity between real and synthetic feature values, ensuring models can recognize and act on underlying patterns. Yet, the domain of network dataset augmentation presents unique challenges. While the synthetic data's quality in ML applications is useful, its utility extends beyond. The data's relevance in traditional network analysis and testing tasks-often requiring raw network traffic-becomes equally significant. Despite the guidance provided by ControlNet during the generation process, converting the synthetic encoded traffic back to raw formats, like PCAP, is not straightforward. This complexity arises from the multitude of detailed transport and network layer protocol rules at both inter and intra-packet levels. Properly formatted traffic should adhere to these rules.

At its core, both transport and network layer protocol rules define the conventions and constraints that facilitate communication between devices in a network. These rules are useful as they dictate the structure, formatting, and sequencing of packets, so that data transmission occurs efficiently and reliably. While transport layer rules emphasize end-to-end communication and reliability, network layer protocols focus on packet routing and address assignment. Combined, these rules can be broadly divided into two categories.

Inter-Packet Rules: These rules define the relationships and sequencing between header fields within multiple packets in a network flow. For instance, in a typical TCP connection, packets need to be sequenced properly, starting with the handshake process involving SYN and SYN-ACK flags. The integrity of data transfer is ensured by aligning sequence numbers and acknowledgment numbers. Misalignment or incorrect sequencing can disrupt the connection or data transfer process.

Intra-Packet Rules: These rules pertain to the structure and contents within individual packets. For example, many protocol headers have a checksum field computed based on the packet's contents to detect errors during transmission. It is desirable for the checksum to be consistent with the packet's payload. Additionally, certain fields within a packet, such as port numbers in TCP and UDP headers, must adhere to specific formatting and value constraints to ensure the packet's validity and proper routing.

Compliance with these rules is desirable. Properly formatted traffic is not only more efficient but also needed for network applications and devices, such as analysis tools, routers, and firewalls, which rely on well-structured packets to function correctly. The challenge with synthetic data generation, especially when designed for ML accuracy, is that ML models primarily focus on patterns within features that contribute to classification or prediction accuracy. These models might overlook intricate protocol rules in favor of patterns that enhance classification performance. For example, a ML model might deem certain bit patterns as significant for classifying a particular type of traffic, even if those patterns violate protocol rules. While the use of ControlNet aids in approximating the general protocol and header field value distributions by ensuring correct field population, it does not fully capture the nuances of specific bit-level values.

This disparity between ML design and protocol rule compliance accentuates the desirability of post-generation adjustments. Instead of entirely overhauling the ML generation process, which would require embedding a vast amount of rule-bound constraints derived from domain knowledge, post-generation adjustments offer a more manageable approach to refine the generated data for protocol compliance. Implementing such detailed control during generation remains a challenging endeavor.

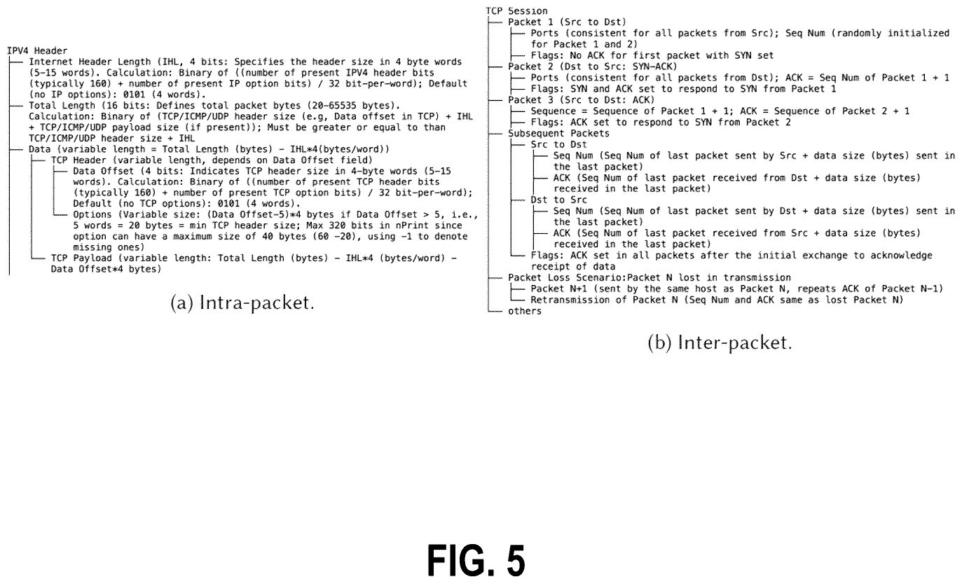

To increase the encoded synthetic network traffic's compliance with transport and network layer protocol rules, a subset of specific header fields that mandate strict adherence to their formatting rules, e.g., sequence and acknowledgement numbers, are discerned. In contrast, some fields can accommodate a degree of flexibility without compromising the integrity of the network traffic, such as TCP window size or TTL. The objective here is to limit the scope of fields requiring modification during post-processing, so that the original generative model's output is largely retained. With these fields identified, two dependency trees are constructed-one for intra-packet header field dependencies and another for inter-packet dependencies. These trees are built upon domain knowledge and are sourced from standard network protocol documentation. FIG. 5 depicts example protocol rules and the associated dependency trees for TCP.

Given generated and encoded network traffic, the correction process begins by traversing the trees in an automated, bottom-up fashion. Initially, intra-packet dependencies are satisfied, so that individual packets are internally consistent. Subsequently, inter-packet dependencies are addressed, so that the packets in a flow relate correctly to one another. Certain fields necessitate uniformity across packets within the same network traffic trace, such as like IP addresses and ports. Others require specific initialization values, such as the IP identification number and TCP acknowledgment number. To determine the most appropriate values for these fields, a majority voting system is employed by selecting the most frequently appearing value within the generated traffic.

Another notable challenge is timestamp assignment for individual packets, given its intricate time-series dependencies. Diffusion models, while adept at spatial dependencies, might struggle with long-range temporal patterns inherent in time-series. As possible solution, original time distributions from real traffic are sampled to produce similar timestamp distribution in the post-generated synthetic data.

Post these steps, the synthetic traffic should be in a state where it closely adheres to the protocol rules. This post-processing makes it so that the encoded synthetic traffic can be seamlessly converted into raw network traffic formats (like PCAP) and subsequently be utilized for a range of non-ML tasks.

### D. Evaluation

To assess the effectiveness of the generative framework, it was applied to an exemplary real network traffic dataset, generating its synthetic counterpart as a case study. The ML-oriented evaluation comprises two main analyses: a statistical comparison to gauge the fidelity of the synthetic data and a model accuracy assessment to determine its utility in enhancing ML outcomes. The non-ML scenarios explore the broader implications of the synthetic data by applying it in diverse network analysis and testing scenarios. The choice of the baseline dataset, which is detailed next, serves as a demonstration of the validity of the embodiments herein.

### 1. Dataset Overview and Synthetic Traffic Generation

TABLE 2
Summary of the real network traffic dataset, 10 applications
across these three macro service types.

| | Total | Application | Collection |
|---|---|---|---|
| Macro Services | Flows | Labels | Date |
| Video Streaming | 9465 | Netflix | 2018 Jun. 1 |
| | | YouTube | |
| | | Amazon | |
| | | Twitch | |
| Video Conferencing | 6511 | MS Teams | 2020 May 5 |
| | | Google Meet | |
| | | Zoom | |
| Social Media | 3610 | Facebook | 2022 Feb. 8 |
| | | Twitter | |
| | | Instagram | |

The dataset for real network traffic, summarized in Table 2, comprises PCAP files accumulated over different periods, capturing traffic from ten prominent applications in areas such as video streaming, video conferencing, and social media. During preprocessing, DNS queries are analyzed to identify relevant IP addresses for the specified services and applications, keep only packets associated with these IPs, and split the traffic into individual flows. The application and service label are retained for each processed flow, which is later used for generating text prompts and assessing classification accuracy.

The comprehensive dataset contains nearly 20,000 flows. For feasibility and consistency in the evaluations, 10% of this collection were randomly sampled. Evaluations were also carried out on both larger and smaller subsets of the dataset and obtained comparable results. The fined-tuned diffusion model was adapted to this dataset, resulting in the generation of a synthetic dataset as outlined in the previous section. The volume of this synthetic dataset adjusts based on specific evaluation requirements, as discussed below. The prompt-driven nature of diffusion model allows for the generation of synthetic network traffic in any desired quantity, providing flexibility for diverse analytical needs.

### 2. Statistical and ML Performance Analysis

A measure of synthetic data quality is its statistical resemblance to the original data. This comparison is notable as the essence of synthetic data lies in its ability to represent the statistical properties of the real data without mirroring it exactly. Providing statistical similarity makes it so that models trained on synthetic data generalize well to real-world scenarios. In evaluations, synthetic data was benchmarked against two baselines: (1) the NetShare method, which produces synthetic NetFlow attributes and outperforms most of the GANs-based methods, and a naive random generation approach. The latter, by generating purely random values, acts as a worst-case scenario, illustrating the lower bounds of similarity and underscoring the value added by more sophisticated methods. While the diffusion models herein inherently capture a broader set of network attributes, for fairness in comparison, similarity is examined both at an aggregated level, encompassing all features, and at a more focused level, targeting the common features between NetDiffusion and NetShare—using the Protocol attribute as an example.

Three distinct metrics can quantify statistical similarity: Jensen-Shannon Divergence (JSD), Total Variation Distance (TVD), and Hellinger Distance (HD). JSD gauges informational overlap between distributions, offering insights into shared patterns. TVD captures the maximum difference between two distributions, highlighting worst-case discrepancies. Meanwhile, HD, rooted in Euclidean distance, is especially sensitive to differences in the tails of distributions, shedding light on distinctions in rare events or outliers. Collectively, these metrics provide a holistic view of the statistical overlap between the real and synthetic datasets. Values for all three metrics range between 0 and 1, with values closer to 0 indicating superior statistical similarity and thus a closer resemblance to the original dataset.

TABLE 3
Average normalized statistical differences between real and synthetic network data across
(1) all generated fields and (2) example commonly generated field - IPv4 protocol: Jensen-
Shannon Divergence (JSD), Total Variation Distance (TVD), and Hellinger Distance (HD).

| | | | | | Ex. | Ex. | Ex. |
|---|---|---|---|---|---|---|---|
| | | All | All | All | Common | Common | Common |
| | | Generated | Generated | Generated | Feature: | Feature: | Feature: |
| Data | Generation | Features | Features | Features | Protocol | Protocol | Protocol |
| Format | Method | Avg. JSD | Avg. TVD | Avg. HD | Avg. JSD | Avg. TVD | Avg. HD |
| NetFlow | Random | 0.67 | 0.80 | 0.76 | 0.82 | 0.99 | 0.95 |
| | Generation | | | | | | |
| NetFlow | NetShare | 0.16 | 0.16 | 0.18 | 0.04 | 0.03 | 0.04 |
| Network | Random | 0.82 | 0.99 | 0.95 | 0.83 | 1.00 | 1.00 |
| Traffic | Generation | | | | | | |
| (PCAP) | | | | | | | |
| Network | Net- | 0.04 | 0.04 | 0.05 | 0.02 | 0.03 | 0.02 |
| Traffic | Diffusion | | | | | | |
| (PCAP) | | | | | | | |

The results in Table 3 offer a nuanced view into the challenges and successes of synthetic data generation for network traffic. At a foundational level, raw network traffic in PCAP format is inherently more intricate than the NetFlow format. This complexity is evident in the stark contrast in statistical distances when generating synthetic data for these two formats using random methods.

The higher statistical distance observed for the randomly generated raw network traffic underscores the inherent challenges in replicating its multifaceted nature. Yet, this very complexity highlights the prowess of NetDiffusion. Despite PCAP being a more challenging format, NetDiffusion, specialized in generating raw network traffic, demonstrates a remarkable capability. Its statistical distances relative to real network traffic are notably lower than even NetShare's distances when NetShare is generating for the simpler NetFlow attributes. This finding underscores the efficacy of NetDiffusion in producing high-fidelity synthetic data for intricate formats like PCAP.

In summary, while the inherent challenges in replicating the complex PCAP format are evident, NetDiffusion's capability to produce synthetic data with high statistical similarity, even surpassing methods for simpler formats, validates its potential as a robust tool for data augmentation in the realm of raw network traffic.

To gauge the efficacy of the synthetic network traffic in ML-based data augmentation, two classification tasks are employed. The first task aims to categorize network flows at a granular level, aligning them with their corresponding applications (microlevel). The second task operates at a broader scale, classifying flows into their overarching services (macro-level). Evaluation is performed using three prominent models, including random forest (RF), decision tree (DT), and support vector machine (SVM). Accuracy is used as the performance metric for these ML-driven augmentation evaluations due to its intuitive interpretability, allowing for a straightforward comparison between different augmentation techniques. Specifically, in scenarios involving classification tasks where classes are (or are made to be) approximately balanced, accuracy provides a clear picture of how well the model performs across all classes. Three distinct augmentation scenarios, utilizing the synthetic data, are evaluated.

First, complete synthetic data usage. Here, either the training or testing set is entirely composed of synthetic data, e.g., training exclusively on synthetic data and testing on real data, and vice versa. This approach tests the robustness of synthetic data and its capacity to emulate real-world data intricacies. Using synthetic data in isolation ensures that models are not biased by any inherent patterns of the real dataset during training, allowing for an assessment of the synthetic data's standalone quality.

Second, mixed data proportions. Synthetic data is interspersed with real data at varying proportions, e.g., a 50-50 split between synthetic and real data during training. This strategy evaluates the synergy between real and synthetic data. Mixing allows models to benefit from the diversity of synthetic data while still grounding the learning process in real-world patterns, potentially improving generalization.

Third, class imbalance rectification. Synthetic data is employed specifically to address and rectify class imbalances in the training set. For instance, underrepresented classes in the real dataset are augmented using synthetic data until a balance is achieved. This targeted augmentation ensures that the model is exposed to a balanced representation of all classes, mitigating biases and improving performance on minority classes. Addressing class imbalance is desirable as it prevents models from becoming skewed towards overrepresented classes, thereby enhancing their predictive accuracy across all classes.

TABLE 4
Across all complete synthetic data usage scenarios, NetDiffusion
augmented dataset yields to higher classification accuracy.
Only the top-performing model is displayed.

| | | | Highest | | Highest | |
|---|---|---|---|---|---|---|
| | Data Format | | Accuracy | | Accuracy | |
| | (Generation | Post-Gen. | (Model) | | (Model) | |
| Training/Testing | Method) | Heuristic | Macro-level | | Micro-level | |
| Real/Real | Network traffic | N/A | 1.00 | (SVM) | 0.978 | (SVM) |
| | (N/A) | | | | | |
| Real/Real | Netflow (N/A) | N/A | 0.86 | (RF) | 0.648 | (DT) |
| Synthetic/Real | Network traffic | Not Used | 0.738 | (DT) | 0.262 | (DT) |
| | (NetDiffusion) | | | | | |
| Synthetic/Real | Network traffic | Used | 0.676 | (DT) | 0.222 | (DT) |
| | (NetDiffusion) | | | | | |
| Synthetic/Real | Netflow | N/A | 0.396 | (RF) | 0.140 | (SVM) |
| | (NetShare) | | | | | |
| Real/Synthetic | Network traffic | Not Used | 0.542 | (SVM) | 0.249 | (SVM) |
| | (NetDiffusion) | | | | | |
| Real/Synthetic | Network traffic | Used | 0.529 | (SVM) | 0.182 | (SVM) |
| | (NetDiffusion) | | | | | |
| Real/Synthetic | Netflow | N/A | 0.503 | (SVM) | 0.102 | (RF) |
| | (NetShare) | | | | | |

TABLE 5
Macro-level RF feature importance for complete NetDiffusion
synthetic data usage; Green highlights denote shared
header fields with the real/real scenario. Feature structure:
packet_protocol_header_bit.

| Rank | Real/Real | Synthetic/Real |
|---|---|---|
| 1 | 3_tcp_wsize_13: 0.0115 | 1_tcp_opt_92: 0.0125 |
| 2 | 3_tcp_wsize_15: 0.0107 | 2_udp_cksum_14: 0.0098 |
| 3 | 1_udp_len_5: 0.0100 | 8_tcp_opt_78: 0.0093 |
| 4 | 1_tcp_opt_24: 0.0099 | 4_tcp_opt_93: 0.0085 |
| 5 | 1_ipv4_tl_5: 0.0090 | 9_udp_cksum_14: 0.0085 |
| 6 | 0_tcp_opt_6: 0.0088 | 5_tcp_opt_93: 0.0084 |
| 7 | 0_ipv4_dfbit_0: 0.0088 | 5_tcp_urp_8: 0.0082 |
| 8 | 1_tcp_opt_6: 0.0086 | 9_tcp_cksum_1: 0.0081 |
| 9 | 9_ipv4_proto_3: 0.0085 | 6_tcp_opt_78: 0.0079 |
| 10 | 1_tcp_opt_23: 0.0076 | 2_tcp_opt_93: 0.0079 |

The results presented in Table 4 reveal that the embodiments herein, which specialize in generating raw network traffic data in PCAP format, consistently outperforms the NetShare approach, which is tailored for the simpler NetFlow data format. The rich feature space inherent in raw network traffic offers a plethora of learnable patterns that can bolster model accuracy. With a broader and more intricate feature set, there is more room for the model to identify and leverage intricate patterns, nuances, and correlations within the synthetic network traffic data to enhance its predictive prowess. At the same time, the higher statistical similarity between real and synthetic datasets (as observed previously) implies that the synthetic network traffic data mirrors real-world patterns more closely. This, in turn, means that features in the real dataset that are pivotal in distinguishing between network flows are likely to retain their discriminative power in the synthetic dataset. Such preservation of feature significance makes it so that models trained on synthetic data can generalize more effectively to real-world scenarios. Supporting this is the feature importance analysis for the RF model in the macro-level classification task as shown in Table 5. When trained on NetDiffusion synthetic data and tested on real data, the RF model exhibited a propensity to prioritize features (on the header level) that are also useful when both training and testing are done on real data. This nuanced focus on specific feature subsets is indicative of the model's ability to discern and leverage patterns in the synthetic data that are reflective of real-world traffic.

An additional layer to the analysis pertains to the post-generation heuristic for enhancing the synthetic network traffic's adherence to protocol rules while minimally altering the diffusion-generated outputs. The heuristic affects only ˜8% of the synthetic traffic features which produces marginal influence on ML performance, with accuracy reductions ranging from 0.013 to 0.067 across all scenarios.

The term “mixing rate” denotes the percentage of real data replaced by synthetic data in the training set. This approach makes it so that the training set size remains constant across diverse mixing rates, enabling a clear evaluation of the interplay between the mixing rate and the resultant model accuracy. Introducing a controlled blend of synthetic data into real datasets can often enhance model robustness by potentially introducing diverse patterns, a practice that is considered standard in data augmentation.

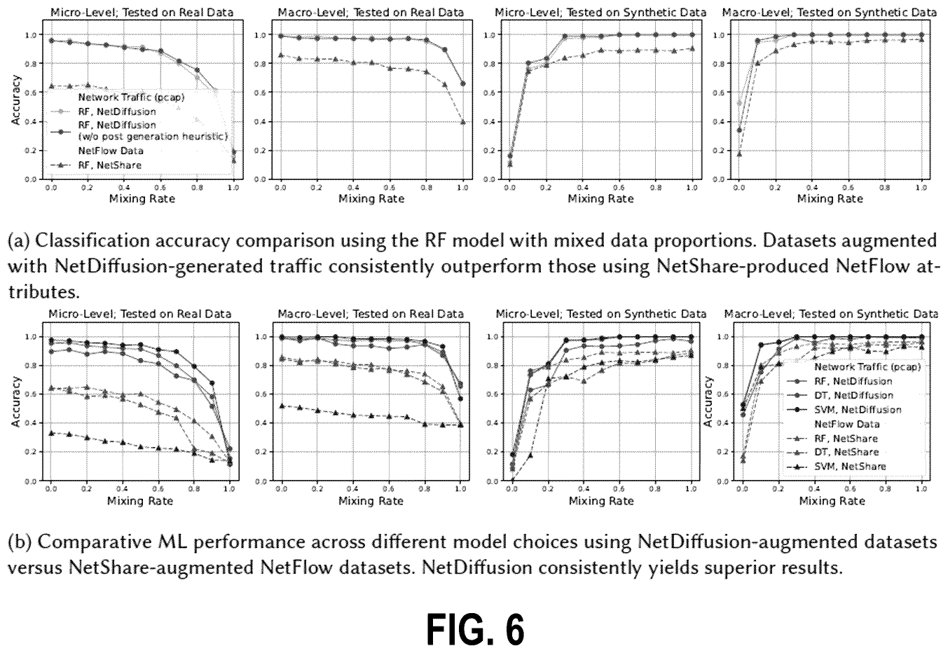

Using the RF model as an example, FIG. 6 part (a) shows that models trained with dataset augmented with NetDiffusion-generated traffic consistently achieve higher classification accuracy than those with NetShare-produced NetFlow attributes. When testing on real data, models trained entirely on real network traffic demonstrate notably higher accuracy than those trained solely on real NetFlow (also highlighted in Table 4). This starting accuracy discrepancy is can be useful. When integrating synthetic network traffic data into training, any potential degradation in accuracy is offset by the inherently higher baseline accuracy of real network traffic. In simpler terms, with a more accurate starting point (real network traffic), there exists more “buffer” before accuracy noticeably degrades.

Another factor is the higher statistical similarity of NetDiffusion-generated traffic to real data, compared to the similarity of NetShare's NetFlow data to real NetFlow. With this closer resemblance, as more synthetic data is incorporated into the training, the gradual decline in accuracy is less pronounced than when using NetFlow data, especially in macro-level classification. This advantage is not confined to testing on real data. Even when evaluating on synthetic data, models trained with NetDiffusion's output generally outperform those trained with NetShare. Additionally, a similar analysis is carried out as in the case of complete synthetic data usage by examining the effects of applying the post-generation heuristic on the model accuracy, as depicted in FIG. 6 part (a). Consistent with the previous findings from Table 4, the example RF model experiences little to no accuracy degradation as a result of the post-generation modification.

TABLE 6
Synthetic balancing on under-represented classes to mitigate class imbalance.

| | Mean (μ) | Med | Min | Max | Std Dev (σ) | Var (σ²) |
|---|---|---|---|---|---|---|
| Before Balancing | 10.00% | 8.89% | 4.44% | 17.78% | 5.13% | 26.37% |
| After Balancing | 10.00% | 10.00% | 10.00% | 10.00% | 0.00% | 0.00% |

TABLE 7
Feature importance at varying mixing rates for micro-level classification on real
network traffic data. Red highlights indicate header fields that are not in the
top 10 most important features in the real/real scenario (mixing rate = 0).

| | Mixing Rate (Accuracy) | | |
|---|---|---|---|
| Rank | 0.0 (0.960) | 0.4 (0.928) | 1.0 (0.187) |
| 1 | 5_ipv4_ttl_0: 0.0081 | 5_ipv4_ttl_3: 0.0055 | 5_ipv4_ttl_4: 0.0055 |
| 2 | 4_tcp_wsize_0: 0.0061 | 4_tcp_wsize_31: 0.0047 | 8_tcp_cksum_31: 0.0045 |
| 3 | 5_tcp_wsize_4: 0.0061 | 1_ipv4_dfbit_31: 0.0046 | 4_tcp_opt_31: 0.0042 |
| 4 | 1_ipv4_ttl_0: 0.0059 | 1_ipv4_ttl_31: 0.0045 | 4_ipv4_ttl_5: 0.0052 |
| 5 | 1_ipv4_dfbit_0: 0.0059 | 1_ipv4_ttl_0: 0.0043 | 5_ipv4_ttl_5: 0.0052 |
| 6 | 1_ipv4_ttl_0: 0.0059 | 2_ipv4_ttl_0: 0.0041 | 1_udp_cksum_24: 0.0040 |
| 7 | 4_ipv4_dfbit_0: 0.0058 | 4_ipv4_ttl_4: 0.0041 | 4_ipv4_ttl_4: 0.0039 |
| 8 | 4_ipv4_ttl_5: 0.0058 | 4_tcp_wsize_10: 0.0040 | 3_tcp_opt_31: 0.0038 |
| 9 | 5_ipv4_ttl_1: 0.0053 | 5_ipv4_ttl_31: 0.0037 | 2_ipv4_ttl_4: 0.0037 |
| 10 | 1_tcp_opt_54: 0.0053 | 1_tcp_opt_11: 0.0036 | 8_tcp_wsize_13: 0.0034 |

TABLE 8
Comparison of micro-level classification accuracy. Class balancing using NetDiffusion
synthetic data contributes to accuracy improvement on minority classes.

| Training Data | | Test Accuracy Pre/Post | |
|---|---|---|---|
| (Balancing Source) | Model | Balancing | Δ Acc. |
| Network Traffic | RF | 0.982 → 0.986 | 0.004 (Facebook |
| (NetDiffusion) | | | 0.955 → 1.00) |
| | DT | 0.973 → 0.982 | 0.009 (Meet |
| | | | 0.99 → 1.00) |
| | SVM | 0.991 → 0.991 | 0 (Zoom 0.955 → 1.00) |
| Netflow Data (NetShare) | RF | 0.645 → 0.628 | −0.017 |
| | DT | 0.603 → 0.600 | −0.003 |
| | SVM | 0.290 → 0.290 | 0 |

A notable observation is the sharp decline in accuracy when the data composition of the training set diverges significantly from the test set. For instance, macro-level classification accuracy drops when the mixing rate exceeds 0.8. This is expected since adequate samples from the test data distribution are needed in the training set for effective cross-validation. As the mixing rate increases, models might overfit the synthetic data, hindering their performance on real data. This behavior is evident in the changing feature importance with increasing mixing rates, as seen in Table 7. In practical scenarios, it is rare to rely heavily or solely on synthetic data for training. The results suggest that, barring extremes, NetDiffusion-generated traffic can be effectively used for training.

Lastly, it is shown that across different model choices, as in FIG. 6 part (b), NetDiffusion-augmented datasets generally lead to better ML performance than NetShare-augmented NetFlow datasets. Notably, the SVM classifier demonstrates markedly superior performance when tasked with classifying raw network traffic as opposed to NetFlow traffic. SVMs are intrinsically adept at handling datasets with high dimensionality and complex relationships between features. The reason lies in SVM's ability to transform the original data into a higher-dimensional space and find hyperplanes to segregate different classes. The richer and more intricate the feature space, the more advantageous this capability becomes. This observation accentuates the importance of NetDiffusion in generating synthetic network traffic, which retains the intricacies of real traffic, allowing sophisticated classifiers like SVM to effectively discern patterns and relationships.

Class imbalance is a ubiquitous challenge in many datasets used for training. For instance, in the collected network trace, the least represented application class constituted a mere 4.44% of the total flow samples, while the dominant class accounted for 17.78%, as shown in Table 6. Such imbalances can negatively skew model performance, as models trained on imbalanced data may struggle to correctly classify underrepresented classes, especially when real-world test data exhibits a more balanced distribution. To combat this, a plausible approach is to selectively augment the training set by appending synthetic data to minority classes, such that an even class distribution. Simultaneously, by limiting the addition of synthetic data to well-represented classes, the drawbacks associated with integrating synthetic data are reduced, such as the risk of accuracy degradation from overly introduced variations and insufficient amount of real data in the training set, as observed in the case of mixed data proportions. Using synthetic data offers advantages over traditional methods like SMOTE, random oversampling, ADASYN, and boosting. It produces diverse and novel examples, enriching the feature space and bolstering model generalization to unseen real-world scenarios. While techniques like SMOTE replicate close counterparts of real data, they might miss certain variations.

Synthetic balancing is applied using NetDiffusion-generated network traffic, resulting in a balanced network traffic dataset across all applications. Similarly, the NetFlow dataset is balanced using synthetic attributes from NetShare. The evaluation reveals that models trained on the balanced NetDiffusion dataset either match or outperform those trained on the original imbalanced dataset as shown in Table 8. Notably, the accuracy gains were predominantly attributed to the improved performance on the previously underrepresented classes. For instance, with the DT model, a notable 0.09 increase in overall classification accuracy is observed using the NetDiffusion augmented dataset. A breakdown of this improvement pinpoints Meet and Zoom traffic, two underrepresented classes with sample counts roughly half or less than the most populated class in the original real dataset, as the primary beneficiaries. Their classification accuracies improved by 0.091 and 0.045, respectively. In contrast, classifiers trained using the NetShare augmented NetFlow dataset do not yield such gains and occasionally even faced accuracy degradation. This further underscores the higher fidelity of NetDiffusion-generated traffic, which not only mirrors real data more closely but also supports a larger feature space to enhance model performance.

### 3. Extendibility to Additional Network Analysis and Testing Tasks

The efficacy of synthetic data augmentation extends beyond just ML performance, especially within the networking realm. While ML-centric tasks may primarily focus on ensuring that generated, encoded network traffic produces a consistent feature set with high statistical similarity to real traffic, conventional network analysis and testing tasks demand the conversion of this generated data back into raw formats, such as packet captures. Moreover, these tasks require adherence to specific protocol rules, as elaborated above. By harnessing the capabilities of ControlNet and the post-generation heuristics, NetDiffusion facilitates the generation of network traffic that can be converted into raw packet captures while maintaining a robust adherence to protocol rules.

To illustrate this, the synthetic e-commerce network traffic generated by NetDiffusion is used as an example and shows that (1) the generated traffic can be smoothly parsed and interpreted by Wireshark, a renowned network analysis tool, without encountering exceptions and (2) the synthetic traffic supports retransmission, as corroborated using the established packet retransmission tool, tcpreplay. Beyond these observations, it is demonstrated that NetDiffusion-generated traffic can successfully support a broad spectrum of common network tasks, ranging from intricate traffic analyses to network behavior studies. The derived features routinely employed in these tasks can be extracted from NetDiffusion's outputs using Scapy. This underscores the versatility of the embodiments herein, suggesting that NetDiffusion's synthetic network traffic can integrate into a multitude of network analysis and testing tasks beyond the confines of ML-centric applications.

TABLE 9
Wireshark capinfos validation log on parsing NetDiffusion
generated Amazon network traffic.

| Attribute | Value | |
|---|---|---|
| File type | Wireshark/tcpdump/ . . . - pcap | |
| File encapsulation | Raw IP | |
| File timestamp precision | microseconds (6) | |
| Packet size limit (file hdr) | 65535 | bytes |
| Number of packets | 1,024 | |
| File/Data size | 1,335 kB/1,318 kB | |
| Capture duration | 0.602296 | seconds |

| | |
|---|---|
| First/last packet time (absolute) | 00:00:00.000000/00:00:00.602296 |
| Data byte/bit rate | 2,189 kBps/17 Mbps |
| Average packet size/rate | 1287.76 bytes/1,700 packets/s |
| Strict time order | True |
| Number of interfaces in file | 1 |
| Interface #0 info | Encapsulation = Raw IP (129 - rawip4) |
| | Capture length = 65535 |
| | Time precision = microseconds (6) |
| | Time ticks per second = 1000000 |
| | Number of stat entries = 0 |
| | Number of packets = 1024 |

TABLE 10
Tcpreplay results on retransmitting NetDiffusion
generated e-commerce network traffic.

| Metric | Value | |
|---|---|---|
| Total Packets Sent | 1024 | |
| Total Bytes Sent | 1318664 | bytes |
| Duration | 0.613297 | seconds |
| Rate (Bps) | 2150123.0 | Bps |
| Rate (Mbps) | 17.20 | Mbps |
| Packets per Second (pps) | 1669.66 | pps |
| Total Flows | 2 | |
| Flows per Second (fps) | 183.06 | fps |

| | |
|---|---|
| Unique Flow Packets | 1024 |
| Successful Packets | 1024 |
| Failed Packets | 0 |
| Truncated Packets | 0 |
| Retried Packets (ENOBUFS) | 0 |
| Retried Packets (EAGAIN) | 0 |

Table 9 details the results from Wireshark's parsing of the NetDiffusion synthetic traffic, stored as a capsinfo log. Several observations can be drawn: (1) Data Format and Integrity: The generated traffic is stored in the standard PCAP format with raw IP encapsulation. This confirms the synthetic data's adherence to widely accepted network trace data formats, ensuring broad compatibility with networking tools. (2) Comprehensive Metrics: All the essential metrics that Wireshark uses to describe and analyze traffic are present, ranging from packet count and data size to encapsulation and timing details. These observations underscore the design's success in producing protocol rule-compliant synthetic traffic, ensuring compatibility with analysis tools like Wireshark that demand structural and semantic correctness.

Table 10 shines light on the retransmission capabilities of the synthetic traffic via tcpreplay. Notable results are: (1) Successful Retransmission: All 1,024 packets were successfully sent without any failures or truncations, indicating the traffic's high fidelity and adherence to transport layer protocol rules. (2) Correct Packet Handling: Metrics like retried packets standing at zero and the exact match of unique flow packets to successful packets further reiterate the synthetic traffic's quality. (3) Metrics Completeness: Key metrics like data bit rate and packet rate, essential for evaluating traffic characteristics, are present and well-defined.

TABLE 11
Comparison of real and generated e-commerce network traffic.

| | | | | Value |
|---|---|---|---|---|
| | | | | (NetDiffusion |
| | | | Value (Real | Generated |
| Network Task | Metric | Unit | Network Traffic) | Traffic) |
| Traffic Analysis | Packet Count | packets | 1024 | 1024 |
| | Byte Count | bytes | 1100406 | 1318664 |
| | Avg. TCP Window | bytes | 32739.95 | 13234.63 |
| | Size | | | |
| Protocol Analysis | Protocol | packets | TCP: 1024, UDP: | TCP: 1024, UDP: |
| | Distribution | | 0, ICMP: 0 | 0, ICMP: 0 |
| | Flags Distribution | flags | SYN: 0, ACK: | SYN: 68, ACK: |
| | | | 1023, FIN: 0, RST: | 574, FIN: 556, |
| | | | 0, PSH: 0, URG: 16 | RST: 1, PSH: 6, |
| | | | | URG: 495 |
| | Src Port | port (packets) | 46508 (303), | 30202 (376), |
| | Distribution | | 443 (721) | 14443 (648) |
| | Dest Port | port (packets) | 443 (303), | 14443 (376), |
| | Distribution | | 46508 (721) | 30202 (648) |
| Network | Packet Size | packets | 0-499: 306, 500- | 0-499: 35, 500-999: |
| Performance | Distribution | | 999: 6, 1000-1499: | 56, 1000-1499: 257 |
| | | | 196, 2000++: 0 | |
| Device | Src IP Distribution | packets | 192.168.43.37 (303), | 156.76.135.124 (376), |
| Identification | | | 54.182.199.148 (721) | 132.81.26.166 (648) |
| | Dest IP | packets | 54.182.199.148 (303), | 132.81.26.166 (376), |
| | Distribution | | 192.168.43.37 (721) | 156.76.135.124 (648) |
| Routing Behavior | Average TTL | seconds | 186.51 | 123.33 |
| User Behavior | Number of | sessions | 1 | 1 |
| | Sessions | | | |
| Error Analysis | Checksum Errors | packets | 0 | 0 |
| | Fragmented | packets | 0 | 0 |
| | Packets | | | |
| | Fragmented IP | datagrams | 0 | 0 |
| | Datagrams | | | |

One of the distinguishing attributes of NetDiffusion generated traffic, compared to earlier works like NetShare, is the ability to derive detailed metrics from the synthetic traffic using tools such as Scapy, making it exceptionally valuable for an expansive range of network analysis tasks. To demonstrate this, the applicability of the synthetic traffic is evaluated on representative tasks including traffic and protocol analysis, network performance assessment, device identification, routing and user behavior characterization, and error evaluation. As shown in Table 11, using e-commerce traffic as an illustrative example, the synthetic network traffic effectively delivers both fundamental metrics, such as packet and byte counts, as well as more nuanced measures like the average TTL used for routing behavior analysis. Furthermore, metrics linked to network performance, device identification, routing behavior, and error analysis further accentuate the synthetic traffic's authenticity and granularity. A noteworthy point is the zero count for error metrics like checksum errors and fragmented packets in both real and synthetic datasets, underscoring the synthetic traffic's semantic correctness. While there are variances between some of the metric values from the synthetic data and real traffic, especially in areas like TCP flag distribution, these differences are inherent to the generative approach. Instead of merely replicating real data values, the method generatively produces them, introducing variations to enhance data diversity. The delicate balance between maintaining the realism of these variations and the utility of the resultant metrics for downstream tasks necessitates a nuanced, task-specific assessment.

In sum, the NetDiffusion generated traffic stands out by allowing the extraction of metrics for additional network tasks, a capability previous techniques lacked due to their inability to produce protocol rule compliant, fine-grained network traffic.

### III. Example Operations

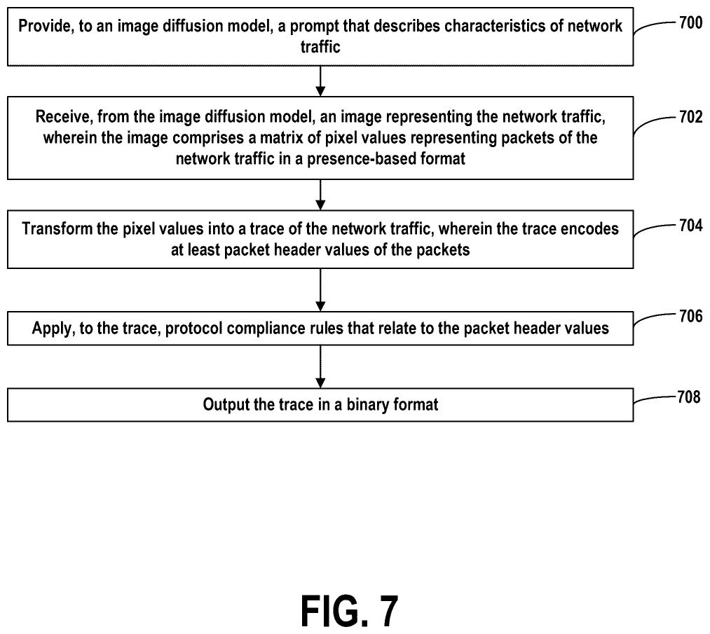

FIG. 7 is a flow chart illustrating an example embodiment. The process illustrated by FIG. 7 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 7 may be simplified by the removal of any one or more of the features shown therein. Further, these embodiments may be combined with features, aspects, and/or implementations of any of the previous figures or otherwise described herein.

Block 700 may involve providing, to an image diffusion model, a prompt that describes characteristics of network traffic.

Block 702 may involve receiving, from the image diffusion model, an image representing the network traffic, wherein the image comprises a matrix of pixel values representing packets of the network traffic in a presence-based format.

Block 704 may involve transforming the pixel values into a trace of the network traffic, wherein the trace encodes at least packet header values of the packets.

Block 706 may involve applying, to the trace, protocol compliance rules that relate to the packet header values.

Block 708 may involve outputting the trace in a binary format.

In some embodiments, the presence-based format encodes bits present in the packet header values with 0's or 1's, wherein the presence-based format encodes bits not present in the packet header values with −1's.

In some embodiments, the matrix of pixel values comprises 2-1024 sequentially-represented packets.

In some embodiments, the prompt is a textual prompt.

In some embodiments, applying the protocol compliance rules comprises adjusting sequence numbers, acknowledgment numbers, checksums, or port numbers of the packet header values according to a dependency tree of protocol rules.

In some embodiments, applying the protocol compliance rules further comprises traversing the dependency tree to modify the packet header values until interdependencies in the packet header values satisfy the protocol rules.

In some embodiments, the protocol compliance rules comprise intra-packet dependency rules, including recalculating checksums based on payload and header contents for one or more of the packet header values.

In some embodiments, the protocol compliance rules comprise inter-packet dependency rules, including aligning sequence numbers and acknowledgment numbers across a plurality of the packet header values in a flow of the packets represented in the trace.

Some embodiments further involve providing the trace in the binary format to a traffic replay utility configured to retransmit the trace of the network traffic in a live network environment.

Some embodiments further involve using the trace in the binary format to augment training of a machine learning model configured to classify further network traffic.

In some embodiments, each row of the matrix corresponds to a packet and each column corresponds to a bit position within a header of the packet.

Some embodiments further involve: obtaining captured network traffic including a sequence of packet headers; converting the captured network traffic into image-based representations, wherein each respective image of the image-based representations includes a respective matrix of pixel values representing respective packets of the captured network traffic in the presence-based format; associating the image-based representations with prompts describing characteristics of the captured network traffic; and fine-tuning the image diffusion model with the image-based representations and the associated prompts.

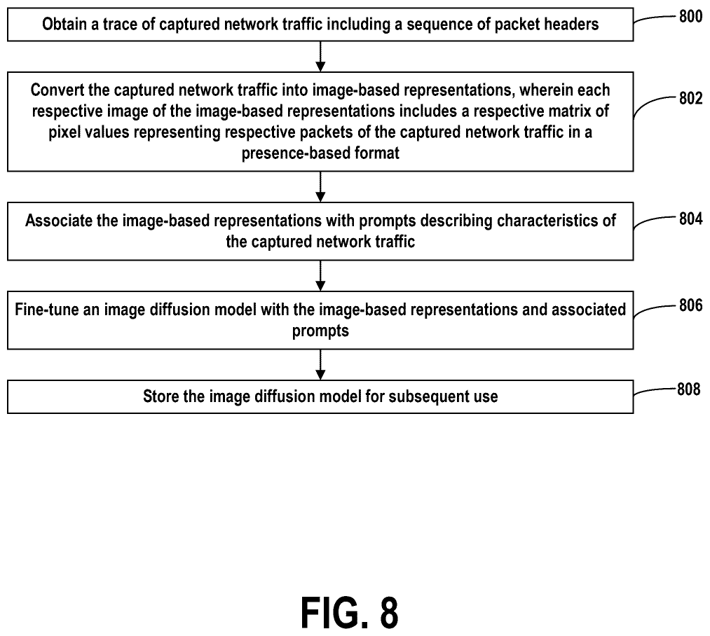

FIG. 8 is a flow chart illustrating an example embodiment. The process illustrated by FIG. 8 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 8 may be simplified by the removal of any one or more of the features shown therein. Further, these embodiments may be combined with features, aspects, and/or implementations of any of the previous figures or otherwise described herein

Block 800 may involve obtaining a trace of captured network traffic including a sequence of packet headers.

Block 802 may involve converting the captured network traffic into image-based representations, wherein each respective image of the image-based representations includes a respective matrix of pixel values representing respective packets of the captured network traffic in a presence-based format.

Block 804 may involve associating the image-based representations with prompts describing characteristics of the captured network traffic.

Block 806 may involve fine-tuning an image diffusion model with the image-based representations and associated prompts.

Block 808 may involve storing the image diffusion model for subsequent use.

In some embodiments, the presence-based format encodes bits present in the packet headers with 0's or 1's, wherein the presence-based format encodes bits not present in the packet headers with −1's.

In some embodiments, each respective matrix of pixel values comprises 2-1024 sequentially-represented packets.

In some embodiments, the associated prompts include textual prompts that identify traffic classes of the captured network traffic used to form the image-based representations.

In some embodiments, fine-tuning the image diffusion model comprises applying Low-Rank Adaptation to modify a pre-trained image diffusion model using the image-based representations and the associated prompts.

In some embodiments, fine-tuning the image diffusion model comprises conditioning the image diffusion model with control inputs that constrain generation of packet header fields to distributions observed in real network traffic.

In some embodiments, each row of each respective matrix of pixel values corresponds to a packet and each column of each respective matrix of pixel values corresponds to a bit position within a header of the packet.

Herein, the presence-based format described above may be a data representation scheme in which each bit position of a packet header is encoded into a pixel value of an image matrix, such that the value of the pixel reflects whether a particular bit is present and set, present and unset, or not present at all. For example, a set bit is encoded with a value of 1, an unset bit is encoded with a value of 0, and a bit that is not defined or absent for a given packet header field is encoded with a value of −1. This three-valued scheme allows for faithful representation of packet header fields of varying structure and length in a fixed-dimensional image space, while preserving information about both the presence and absence of protocol fields across different packets.

### IV. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
providing, to an image diffusion model, a prompt that describes characteristics of network traffic;
receiving, from the image diffusion model, an image representing the network traffic, wherein the image comprises a matrix of pixel values representing packets of the network traffic in a presence-based format;
transforming the pixel values into a trace of the network traffic, wherein the trace encodes at least packet header values of the packets;
applying, to the trace, protocol compliance rules that relate to the packet header values; and
outputting the trace in a binary format.

2. The computer-implemented method of claim 1, wherein the presence-based format encodes bits present in the packet header values with 0's or 1's, and wherein the presence-based format encodes bits not present in the packet header values with −1's.

3. The computer-implemented method of claim 1, wherein the matrix of pixel values comprises 2-1024 sequentially-represented packets.

4. The computer-implemented method of claim 1, wherein the prompt is a textual prompt.

5. The computer-implemented method of claim 1, wherein applying the protocol compliance rules comprises adjusting sequence numbers, acknowledgment numbers, checksums, or port numbers of the packet header values according to a dependency tree of protocol rules.

6. The computer-implemented method of claim 5, wherein applying the protocol compliance rules further comprises traversing the dependency tree to modify the packet header values until interdependencies in the packet header values satisfy the protocol rules.

7. The computer-implemented method of claim 1, wherein the protocol compliance rules comprise intra-packet dependency rules, including recalculating checksums based on payload and header contents for one or more of the packet header values.

8. The computer-implemented method of claim 1, wherein the protocol compliance rules comprise inter-packet dependency rules, including aligning sequence numbers and acknowledgment numbers across a plurality of the packet header values in a flow of the packets represented in the trace.

9. The computer-implemented method of claim 1, further comprising:
providing the trace in the binary format to a traffic replay utility configured to retransmit the trace of the network traffic in a live network environment.

10. The computer-implemented method of claim 1, further comprising:
using the trace in the binary format to augment training of a machine learning model configured to classify further network traffic.

11. The computer-implemented method of claim 1, wherein each row of the matrix corresponds to a packet and each column corresponds to a bit position within a header of the packet.

12. The computer-implemented method of claim 1, further comprising:
obtaining captured network traffic including a sequence of packet headers;
converting the captured network traffic into image-based representations, wherein each respective image of the image-based representations includes a respective matrix of pixel values representing respective packets of the captured network traffic in the presence-based format;
associating the image-based representations with prompts describing characteristics of the captured network traffic; and
fine-tuning the image diffusion model with the image-based representations and the associated prompts.

13. A computer-implemented method comprising:
obtaining a trace of captured network traffic including a sequence of packet headers;
converting the captured network traffic into image-based representations, wherein each respective image of the image-based representations includes a respective matrix of pixel values representing respective packets of the captured network traffic in a presence-based format;
associating the image-based representations with prompts describing characteristics of the captured network traffic;
fine-tuning an image diffusion model with the image-based representations and associated prompts; and
storing the image diffusion model for subsequent use.

14. The computer-implemented method of claim 13, wherein the presence-based format encodes bits present in the packet headers with 0's or 1's, and wherein the presence-based format encodes bits not present in the packet headers with −1's.

15. The computer-implemented method of claim 13, wherein each respective matrix of pixel values comprises 2-1024 sequentially-represented packets.

16. The computer-implemented method of claim 13, wherein the associated prompts include textual prompts that identify traffic classes of the captured network traffic used to form the image-based representations.

17. The computer-implemented method of claim 13, wherein fine-tuning the image diffusion model comprises applying Low-Rank Adaptation to modify a pre-trained image diffusion model using the image-based representations and the associated prompts.

18. The computer-implemented method of claim 13, wherein fine-tuning the image diffusion model comprises conditioning the image diffusion model with control inputs that constrain generation of packet header fields to distributions observed in real network traffic.

19. The computer-implemented method of claim 1, wherein each row of each respective matrix of pixel values corresponds to a packet and each column of each respective matrix of pixel values corresponds to a bit position within a header of the packet.

20. A non-transitory computer-readable medium, storing program instructions that, when executed by one or more processors of a computing system, cause the computing system to perform operations comprising:
providing, to an image diffusion model, a prompt that describes characteristics of network traffic;
receiving, from the image diffusion model, an image representing the network traffic, wherein the image comprises a matrix of pixel values representing packets of the network traffic in a presence-based format;
transforming the pixel values into a trace of the network traffic, wherein the trace encodes at least packet header values of the packets;
applying, to the trace, protocol compliance rules that relate to the packet header values; and
outputting the trace in a binary format.
